(19) United States
(12) Patent Application Publication
(10) Pub. No.: US 2018/0172582 A1
(43) Pub. Date: Jun. 21, 2018

(54) Method and arrangement for determining concentration of at least two sample components in solution of at least three components

(71) Applicant: Janesko Oy, Vantaa (FI)

(72) Inventor: Arttu Leinonen, Helsinki (FI)

(73) Assignee: Janesko Oy, Vantaa (FI)

(21) Appl. No.: 15/381,673

(22) Filed: Dec. 16, 2016

(51) Int. Cl. G01N 21/41; G01N 27/06

(52) U.S. Cl. CPC G01N 21/4133; G01N 2021/414; G01N 2201/12; G01N 27/06

(57) ABSTRACT

An arrangement for determining concentration of at least two sample components in solution of at least three components comprises a refractometer as a first instrument for measuring refractive index data as a first quantity of the first sample component. In addition the arrangement comprises a second physical quantity measuring device for measuring second physical quantity as a second quantity data of the second sample component, such as a device for measuring conductivity. The second physical quantity is advantageously essentially independent on said refractive index, but is more strongly dependent on at least concentration of at least one second sample component of said solution. Further the arrangement comprises a data processing unit for determining said concentration of at least two sample components by using said refractive index data and second quantity data in an additive way after a variable substitution performed by said data processing unit on the refractive index data.

### TECHNICAL FIELD OF THE INVENTION

The invention relates to a method and arrangement for determining concentration of at least two sample components in solution of at least three components.

### BACKGROUND OF THE INVENTION

In many processes the determination of the concentration of different components in a solution having a number of components is very important, such as for example for measuring different components in a pulp making process in order to optimize and control parameters related to wood processing.

In most solutions, the concentration of a solute in a solvent can be determined by measuring the refractive index n_{D}. The relation between the refractive index and the concentration depends on the solvent and solute, temperature, and wavelength. In practice, the wavelength-dependency (dispersion) can be avoided by using monochromatic light. The temperature dependency can be eliminated in for example laboratory measurements by thermally controlling the sample, but in process measurements it has to be compensated by using a compensation formula.

In relation to the refractive index the actual numbers vary between different solutions, but usually one percent of concentration corresponds to approximately 0.002 in n_{D}. As a matter of fact, one centigrade in temperature corresponds to 0.0001 in n_{D} in aqueous solutions, but is usually higher with other solvents. As can be understood, the need of temperature measurement and compensation is evident, as a change of one centigrade corresponds typically to a change of 0.05% in the concentration measurement results.

In an exemplary method a refractometer is used for measuring a refractive index of a substance through an optical window. In more details the method includes arranging the optical window in contact with the substance being measured, directing light to the interface of the optical window and substance being measured. A part of the light is refracted into the substance being measured and part of it is reflected from the substance being measured to form an image, in which the location of the boundary of light and dark areas expresses a critical angle of the total reflection dependent on the refractive index of the substance being measured. Light is directed on a first structure and to desired angles on the interface between the optical window and substance being measured. Light reflected from the interface of the optical window and substance being measured is directed on a second structure to an optical measurement element, such as a CCD-camera.

The operating principle of the refractometer can be described generally as follows. The refractometer measures the refractive index of a process solution by means of the total reflection created at the interface between an optical window and the solution. A beam of rays from a light source is directed to the interface between the optical window and the process solution. Part of the beam of rays is reflected from the solution entirely, part of it is refracted partly into the solution. The reflected light rays form an image having light and dark areas. An optical detector is used to measure the location of the boundary of the light and dark areas. This location depends on the critical angle of total internal reflection and thus the refractive index of the measured process solution.

There are however some disadvantages relating to the known prior art. For example in regular binary solutions refractive index itself is easily used as a measure of concentration, but with more than one main component in the mix the behaviour of the addition of more than one component becomes non-linear due to limits in the change of the speed of light in regular solutions. Thus the refractive index, if even used in multi-component solutions, is used as an approximate result and thereby degrading the accuracy typically into undesired level. Thus as soon as the solutions have turned to more than binary solutions refractive index as used previously has become impossible to use accurate enough on solutions where both components are optically active.

In addition it is to be noted that the temperature compensation is not a linear function, and that both the temperature and the concentration change the amount of temperature compensation required. Also, the relationship between concentration and refractive index is nonlinear, whereupon they have additionally made the previous methods very difficult and inaccurate to use.

### SUMMARY OF THE INVENTION

An object of the invention is to alleviate and eliminate the problems relating to the known prior art. Especially the object of the invention is to provide a method and arrangement for determining concentration of at least two sample components in solution of at least three components. In addition the object is to provide a method of calculation to pre-process refractive index data after temperature correction to allow for additive behaviour over various components in the solution.

The object of the invention can be achieved by the features of independent claims.

The invention relates to a method for determining concentration of at least two sample components in solution of at least three components according to claim 1. In addition the invention relates to an arrangement of claim 10.

According to an embodiment of the invention a method for determining concentration of at least two sample components in solution of at least three components comprises measuring a refractive index data as a first quantity. In addition also second physical quantity is measured from the solution as a second quantity data. The second physical quantity is essentially independent on the refractive index, but is more strongly dependent on at least of the concentration of at least one sample component of said solution.

The second quantity can be for example electrical conductivity or density, which behaves as additive quantities and can be summed when measured. However, these two are only examples and the second quantity can also be another quantity as well, as for example viscosity, which is an additive quantity at least with some components, or X-ray absorption or ultrasound velocity, which can be used for example to a density measurement, or optical absorptions, colour determination or (optical) particle counter (slurry), as additional examples.

The typical components are for example salt, sugar, alkalinity (=compound of sodium hydroxide and sodium sulphite), lignin, sulphidity, sodium sulphite, ammonia, ammonium nitrate, hydrogen peroxide, hydrogen chloride or hydrochloric acid, sulfide or sulfuric acid.

Thus when more components are measured, more different second quantities are advantageously selected, measured and determined. According to an example the first quantity for a first component is a refractive index. When the second component, the concentration of which should be determined, is known, a suitable second quantity to be measured is then selected so that the second physical quantity dependents on the concentration change of said second sample component. The second quantity can be for example density. In addition, if the concentration of a third component should be measured, the additional second (or third) quantity is selected so that it dependents on the concentration change of said additional second (or third) sample component. The additional second (or third) quantity can be for example conductivity. The similar principle can be applied also for further additional sample components.

According to an embodiment the concentration of at least two sample components is then determined by using said refractive index data and at least one second quantity data in an additive way after a variable substitution performed on the refractive index data. According to an embodiment the variable substitution to be performed on the refractive index data is implemented by applying Lorenz-Lorentz transformation. This is to modify the refractive index data and enabling to provide a variable, which is then additive sum of the effects of the individual component fractions for determination of said concentration of at least two sample components.

In addition the temperature of the solution is also advantageously measured and a temperature dependent compensation is applied to the measured refractive index data before applying the Lorentz-Lorenz transformation. Also, if there is temperature dependency with the other second quantities, it is also measured and a temperature dependent compensation is applied.

The concentration can then be calculated from the refractive index and temperature by using temperature compensation algorithms when these nonlinear functions are known. In practical use, a simple 3^{rd} degree polynomial in both temperature and concentration (total 16 coefficients) is sufficient.

The temperature correction is advantageously performed by determining at first a difference of Lorenz-Lorentz variable of pure water and Lorenz-Lorentz variable of the sample in question beforehand in order to provide a new temperature dependent variable. Then, afterwards said new variable is used for determining the temperature dependent compensation for the sample components.

As an example the Lorenz-Lorentz variable used to modify the refractive index data is:

$$\frac{{n}^{2} - 1}{{n}^{2} + 2} = {\sum }_{i}^{ } {ρ}_{i} {R}_{i}$$

where ρᵢ is partial density and Rᵢ is specific refractive index of the sample component in question.

As an example, the second physical quantity may be an electrical conductivity of the solution, as described above. The electrical conductivity can be applied when said at least two sample components comprised by said solution is that kind that the electrical conductivity of the first component is essentially negligible in relation to the electrical conductivity of the second component of said at least two sample components. The similar principle applies also when selecting the additional second physical quantities for additional components, as previously discussed.

The relation between the concentration and electrical conductivity of the second component is:

$$κ = F {\sum }_{i}^{ } \vert {z}_{i} \vert {μ}_{i} {c}_{i}$$

where F is Faraday constant, zᵢ is ion charge, cᵢ is ion concentration, and κ is the specific electrical conductivity of the second component. Naturally also the corresponding relation is applied when other second physical quantities are used.

In this example the refractometry and conductometry are successfully combined, since they behave in a purely additive way within the concentration range after the variable substitution performed on the refractive index, as discussed above. The example is very efficient and easy when there are three components presented in the solution, either two solvents and one solute or one solvent and two solutes. However, more components can also exist, whereupon the concentrations of which can be determined by the embodiments described elsewhere in this document, such as using additional second physical quantity, like density or viscosity.

For example the embodiments of the invention can be applied for measuring alkalinity and dry content of black liquour using refractometry and conductivity, for measuring sodium chloride and dextrose using refractometry and conductivity, or for measuring surfactant and thickening agent concentration using refractometry and viscosity. However, these are only examples and should not be understood as a limiting feature for the scope of the claims.

The present invention offers advantages over the known prior art. The invention solves at first the non-linearity inherent in refractive index measurements of more than binary solutions by performing a mathematical transformation that produces a result that behaves in a linear fashion regarding concentrations in ternary and above solutions. Without such transformation the results of refractive index measurement in ternary and above solutions are either inaccurate or misleading, thus degrading severely the resultant accuracy of the calculations being performed.

In addition to making measurements of ternary and above solutions possible with refractive index, the invention also makes it easier to calculate concentrations of binary solutions as most non-linear correlations between concentrations and refractive index can be turned into linear correlations. Moreover the refractive index meters can be used, which are more accurate than for example if only density or viscosity was measured. For example possible drifting is negligible with the refractive index meters, and additionally they are almost free of maintenance, as well as their repeatability is very good. In addition it is to be noted that the refractive index data is temperature corrected thereby to allow for additive behaviour over various components in the solution, which is a clear advantage of the invention.

The exemplary embodiments presented in this text are not to be interpreted to pose limitations to the applicability of the appended claims. The verb “to comprise” is used in this text as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

### BRIEF DESCRIPTION OF THE DRAWINGS

Next the invention will be described in greater detail with reference to exemplary embodiments in accordance with the accompanying drawings, in which:

FIG. 1 illustrates a principle of an exemplary arrangement for determining concentration of at least two sample components in solution of at least three components according to an advantageous embodiment of the invention.

### DETAILED DESCRIPTION

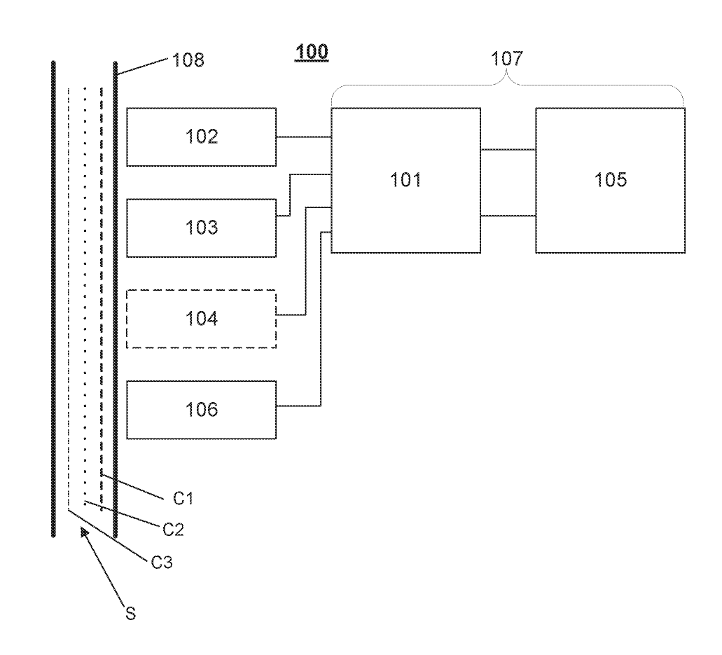

FIG. 1 illustrates an exemplary arrangemnt 100 for determining concentration of at least two sample components in solution of at least three components according to an advantageous embodiment of the invention. The arrangemnt 100 comprises advantageously at least one refractometer 102 as a first instrument for measuring refractive index data as a first quantity of the first sample component C1. In addition the arrangemnt 100 comprises advantageously at least one second physical quantity measuring device 103 for measuring second physical quantity as a second quantity data of the second sample component C2, where said second physical quantity is essentially independent on said refractive index, but is dependent on at least concentration of at least one second sample component of said solution. The arrangement may also comprise further additional second physical quantity measuring device 104 for measuring any additional second physical quantities. As an example the second physical quantity measuring device 103 may for example device for measuring conductivity of the second component C2, and the additional second physical quantity measuring device 104 may be for example device for measuring viscosity or density of the additional second component C3.

The arrangement comprises advantageously also a thermometer 106 for measuring temperature of the solution S (with components C1, C2, C3).

The arrangement also comprises advantageously a data processing unit 107 for determining said concentration of at least two sample components C1, C2, C3 by using said refractive index data and second quantity data in an additive way after a variable substitution performed by said data processing unit on the refractive index data. It is to be noted that the data processing unit 107 can be implemented in many ways, such as at least partly by a computer software product, or by calculation unit 101 and PLC (Programmable logic controller) unit 105, which controls for example the reading of different devices 102, 103, 104, 106 as well as the calculation unit 101.

The data processing unit 107 is advantageously configured to perform variable substitution on the refractive index data implemented by applying Lorenz-Lorentz transformation and so to modify the refractive index data and to provide a variable being additive sum of the effects of the individual component fractions for determination of said concentration of at least two sample components.

As can be seen in FIG. 1 as well as the description above, the exemplary principle of one embodiment of the invention is to use of at least two separate devices 102, 103, 104, one of which is an instrument measuring the refractive index of the sample solution S and the other some complementary measurement to be used in conjunction with the refractive index measurement, e.g. conductivity. The temperature measurement is gained from one of the instruments described previously or from a third separate instrument, such as thermometer 106. All of the instruments are placed as closely as possible in the process pipe 108 so as to get measurements of the same segment of the flow as possible. After the refractive index has been processed as per the description of the invention it is fed into a regular multivariate equation along with the complementary measurement result and the temperature to perform cross and temperature compensations on the variables. After calculation the concentrations of the two (or more) main components C1, C2, C3 in the solution S are provided via various means from the calculation unit 101.

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims. The features recited in dependent claims are mutually freely combinable unless otherwise explicitly stated.

1. A method for determining concentration of at least two sample components in solution of at least three components, wherein the method comprises measuring:
a refractive index data as a first quantity of the first sample component, and
a second physical quantity as a second quantity data of at least one second sample component, where said second physical quantity is essentially independent of said refractive index, but is dependent on at least the concentration of at least one second sample component of said solution, and determining said concentration of at least two sample components by using said refractive index data and second quantity data in an additive way after a variable substitution is performed on the refractive index data.

2. The method of claim 1, wherein the variable substitution performed on the refractive index data is implemented by applying Lorenz-Lorentz transformation so to modify the refractive index data and enabling to provide a linear variable being additive sum of the effects of the individual component fractions for determination of said concentration of at least two sample components.

3. The method of claim 2, wherein temperature of the solution is measured and a temperature dependent compensation is applied to said measured refractive index data before applying said Lorentz-Lorenz transformation.

4. The method of claim 2, wherein the temperature correction is performed by determining at first a difference of Lorenz-Lorentz variable of pure water and Lorenz-Lorentz variable of the sample in question beforehand in order to provide a new temperature dependent variable and afterwards using said new variable for determining the temperature dependent compensation for the sample components.

5. The method of any of claims 2, wherein the Lorenz-Lorentz variable used to modify the refractive index data is:
$$\frac{{n}^{2} - 1}{{n}^{2} + 2} = {\sum }_{i}^{ } {ρ}_{i} {R}_{i}$$
where ρᵢ, is partial density and Rᵢ is specific refractive index of the sample component in question.

6. The method of claim 1, wherein the second physical quantity is electrical conductivity of the solution, where said at least two sample components comprised by said solution is selected so that the electrical conductivity of the first component is essentially negligible in relation to the electrical conductivity of the second component of said at least two sample components.

7. The method of claim 6, wherein the relation between the concentration and electrical conductivity of the second component is:
$$κ = F {\sum }_{i}^{ } \vert {z}_{i} \vert {μ}_{i} {c}_{i}$$
where F is Faraday constant, zᵢ is ion charge, cᵢ is ion concentration, and κ is specific electrical conductivity of the second component.

8. The method of claim 1, wherein said second quantity is at least one of the following: electrical conductivity, density, viscosity, X-ray absorption, ultrasound velocity, optical absorptions, colour determination, or particle counter.

9. The method of claim 1, wherein at least one component of said components is selected from a group of: salt, sugar, alkalinity, lignin, sulphidity, sodium sulphite, ammonia, ammonium nitrate, hydrogen peroxide, hydrogen chloride or hydrochloric acid, sulphide or sulphuric acid.

10. An arrangement for determining concentration of at least two sample components in solution of at least three components, wherein the arrangement comprises:
a refractometer as a first instrument for measuring refractive index data as a first quantity of the first sample component, and
a second physical quantity measuring device for measuring second physical quantity as a second quantity data of the second sample component, where said second physical quantity is essentially independent of said refractive index, but is dependent on at least the concentration of at least one second sample component of said solution, and
a data processing unit for determining said concentration of at least two sample components by using said refractive index data and second quantity data in an additive way after a variable substitution performed by said data processing unit on the refractive index data.

11. The arrangement of claim 10, wherein the data processing unit is configured to perform variable substitution on the refractive index data implemented by applying Lorenz-Lorentz transformation and so to modify the refractive index data and to provide a variable being additive sum of the effects of the individual component fractions for determination of said concentration of at least two sample components.

12. The arrangement of claim 10, wherein the arrangement comprises also a thermometer for measuring temperature of the solution, whereupon the data processing unit is configured to apply a temperature dependent compensation to said measured refractive index data before applying said Lorentz-Lorenz transformation.
